(19) United States
(12) Patent Application Publication
(10) Pub. No.: US 2007/0000170 A1
(43) Pub. Date: Jan. 4, 2007

(54) Plant growth system

(75) Inventor: Eelke Gjalt Hempenius, Deest (NL)

Correspondence Address: DORSEY & WHITNEY LLP, 555 CALIFORNIA STREET, SUITE 1000, SUITE 1000, SAN FRANCISCO, CA, 94104, US

(73) Assignee: Rockwool International A/S, Hedehusene (DK)

(21) Appl. No.: 11/173,810

(22) Filed: Jun. 30, 2005

(51) Int. Cl. A01G 31/00; A01G 31/06; A01G 9/02

(52) U.S. Cl. 47/64; 47/65.5

(57) ABSTRACT

The present invention relates to a plant growth system, comprising a root substrate formed by a number of essentially independent mineral wool elements and a top substrate, comprising an essentially unitary mineral wool element.

### TECHNICAL FIELD

The present invention relates to a plant growth system for growing plants.

### BACKGROUND OF THE INVENTION

It is known to grow plants in a substrate, consisting practically entirely of a monolithic block of mineral wool, as large as the extent of the root system of the plant is expected to be or to become, or even larger, if more than one plant is grown in or on the substrate. As an advantage of such a known technique, control over the plant growth is mainly dependent on product parameters of the specific mineral wool material, employed for manufacturing the block.

As an alternative it is known to employ a collection or number of smaller mineral wool elements, which can for instance be arranged in a container or pot. Such a known technique has an advantage, that roots can easily grow and penetrate into the space occupied by the mineral wool elements, possibly in the spaces between these elements. With the “loose” arrangement of the mineral wool elements, a good and proper distribution of liquids and air can be achieved. However, a disadvantage of such a system is the coherence of the larger number of mineral wool elements, which coherence is in practice more often than not too low, at least too loose for some plants to be grown.

It is known from WO 4004/017.718 that a combination of a lower mineral wool slab in a container with a cover layer of instance peat thereon can be used to grow plants. The disc of mineral wool is primarily intended as a kind of fluid buffer to avoid dehydration of the system, for instance in case of drought.

According to the teachings of U.S. Pat. No. 5,608,989 a substrate for plant growth can be arranged on a mat through which moisture and air can pass.

### SUMMARY OF THE INVENTION

The present invention, in contrast, relates to a plant growth system, comprising a root substrate formed by a number of essentially independent mineral wool elements and a top substrate, comprising at least one essentially unitary or at least coherent mineral wool element.

In specific embodiments of the invention this combination of features can result in a previously unknown coherence of the essentially “loose” mineral wool elements required for growing plants more efficiently, while the top substrate can be utilized to more effectively also perform other functions, that relate to plant growing, such as fluid distribution and release, fixation of the roots for harvesting, etc.

### BRIEF DESCRIPTION OF THE DRAWINGS

FIG. 1 a prospective view of the set up of a number of plant growth systems according to the present invention;

FIG. 2 a cross-section through a plant system according to the present invention;

FIG. 3 a prospective view of a top substrate employed in an embodiment of a system according to the present invention; and

FIG. 4 another example or embodiment of a top substrate for a system according to the present invention.

### DETAILED DESCRIPTION OF THE INVENTION

In certain specific embodiments of the present invention, wherein a container is provided, the top substrate is preferably anchored to the container for stable arrangement of at least the top substrate in the container. Thereby, also the “loose” mineral wool elements can be kept together in a stable manner, providing the desired coherence there between, even though these are loose mineral wool elements. The anchoring means can be embodied in many different ways. For instance, hooks or couplings acting on or between the top substrate and/or the container can be employed. Such a coupling could in an envisaged embodiment, be formed from an inward protrusion at the inner wall of the container, suitable to cooperate with a cut or groove in the circumference of the top substrate. In a preferred embodiment, the top substrate is dimensioned such and in relation to the dimensions of the container, that the top substrate can be placed in a fitting arrangement in the container. By appropriate dimensioning, the anchoring means are thus provided, without having necessarily to provide any additional components, such as a coupling or a hook.

In a further preferred embodiment of the present invention, a top substrate exhibits specifically a horizontal water distributing capability. Thereby, water can be directed to all positions underneath the top substrate, where water may be required by the growing roots of a plant to be grown.

In yet a further preferred embodiment of the present inventions the top substrate exhibits a fluid retention capability combined with a regular fluid release capability. Thereby, a substantially continuous throughput or supply of fluid to the root substrate and thereby to the roots of the growing plant can be achieved. Timing of water supply can hereby be enhanced. Preferably, the top substrate also exhibits a resaturization characteristic, enabling good repeated wettability. Thus, a sufficient capability of being resaturated can be provided, and an improved water management can be enabled.

In another preferred embodiment of the invention the top substrate comprises a disc of mineral wool material. The disc can have any one of a number of circumferential shapes, such as circular, rectangular, symmetrical and elongate, etc. Such shapes are preferably chosen in correspondence with the shape of a container to be used, if a container is actually used. Again, in such an embodiment of the invention, the shape as well as the dimensioning of the mineral wool material top substrate can provide positive placement of the top substrate to achieve a desired degree of coherence within the root substrate, comprising separate mineral wool elements.

In a preferred embodiment of the invention the top substrate comprises a disc of mineral wool material having at least one hole for passage there through of a plant stem. In such an embodiment, the disc of mineral wool material does not form in any way a barrier for root growth of a plant to be grown in the system. Root growth is, from the hole, directed straight into the root substrate, where root growth is positively enhanced due to the loose nature of the individual mineral wool elements.

In yet a further embodiment of the present invention, the top substrate comprises at least one hole for accommodating a plug with a seed, a seedling or a young plant, that is planted in the plug. As such, the top substrate also forms a positioning means, wherein the hole indicates a position, where the plug with the seed, seedling or young plant should be placed.

Further, in yet another preferred embodiment of the present invention, the top substrate can comprise fluid guiding channels for distribution of fluid over or through the top substrate. From the top substrate, the fluid can thereafter be directed into the root substrate in a manner, by which fluid is evenly distributed over the area of the top substrate, where under roots are suspected, expected and intended to grow.

In a further preferred embodiment of the present invention the top substrate comprises at least one planting position and fluid guiding channels for distribution of fluid of the top substrate, where the channels extend radially away from the at least one planting position. In such an embodiment, fluid supply is directed at a position close to the planting position, from which central watering place the fluid is preferably evenly distributed over and through the area, under which root plants are suspected, expected and intended to grow. A non central fluid supply is also envisaged especially in embodiments where the top substrate is designed for an improved water dispersal.

In a preferred embodiment of the present invention the top substrate comprises a disc of mineral wool material having a thickness of between 1 and 10 cm, more preferred of 3-5 cm, and most preferably of approximately 4 cm. Dependent on the material properties of the top substrate other thicknesses can also be chosen, in so far as the underlying root substrate of the loose and individual mineral wool elements can hereby be given a degree of coherence, which is desirable for root growth of plants to be grown.

In yet another preferred embodiment of the invention, the mineral wool material of the top substrate has a density of 40-120 kg/m³, more preferred of 50-100 and most preferably approximately 80 kg/m³. With a density in these ranges, preferred water retention and release properties can easily be achieved.

In yet another preferred embodiment of the present invention the mineral wool elements of the root substrate comprise at least one of blocks, balls, cubes, bars, pills, etc. of mineral wool material. A great many number of possible shapes and forms of the mineral wool elements are possible. One such form is the Growcube® of the present assignee.

Yet further, in a preferred embodiment of the present invention, the mineral wool elements of the root substrate are made from mineral wool material having a density of between 40 and 120 kg/m³, more preferred 50-10, and most preferably approximately 80 kg/m³. In such an embodiment, the material of the mineral wool elements enables that preferred properties of the root substrate can relatively easily be realized.

Preferably, the root substrate and the top substrate exhibit a degree of hydrophilicity, which depends upon the species of the plants to be grown with the plant growth system according to the present invention. For this purpose, several measures can be incorporated into the mineral wool material of the root substrate and of the top substrate. Properties thereof like density, fiber length or orientation, fiber diameter, as well as other parameters and variations thereof in radial, transversal or any other direction may serve to achieve the desired effects of water retention, water release, air retention properties, the capacity of roots to penetrate into the mineral wool material, etc. The mineral wool materials can be provided with additives, such as surfactants, clay, organic, natural hydrophilic components (for example cocos, peat, etc.) and other additives, in order to increase or influence the hydrophilicity of the top substrate and the root substrate. The mineral wool can preferably be bonded with a binder in a conventional manner. Also, the binder can be hydrophilic and most preferably it comprises a furan binder, preferably of the type, described in EP-A-0.849.987. The advantage of such binders is that they provide hydrophilicity to the substrates, but are not washed out during wetting and or drying of the mineral wool materials of the top substrate and of the root substrate, and then still maintain a desired degree of hydrophilicity, exhibiting desired water retention and resaturation properties. Further other additives can also be employed.

Herein below, a preferred embodiment of the present invention will be described, referring to the accompanying drawings, and in which the same reference numbers are used to identify the same or similar aspects and/or components in the different embodiments.

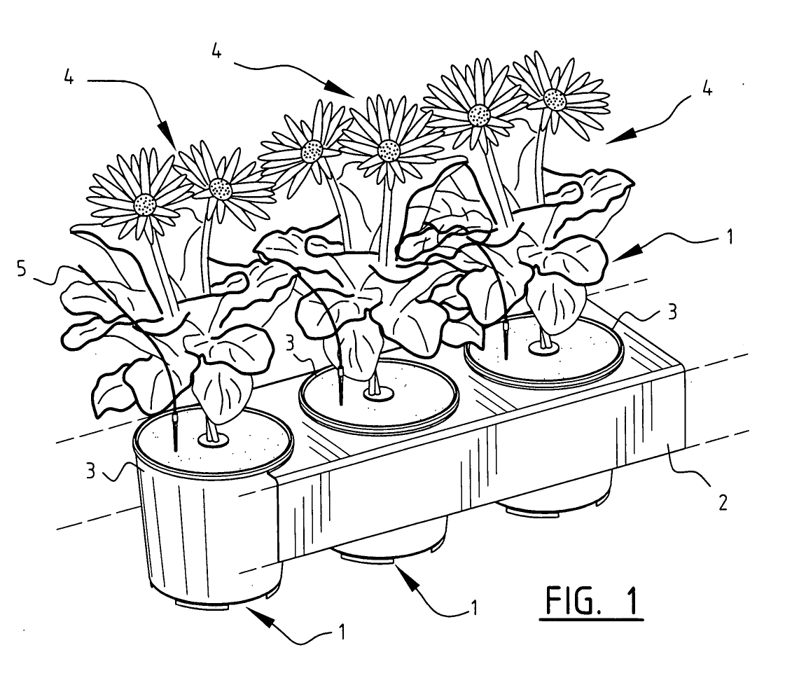

In FIG. 1, a prospective view is shown of three systems 1 according to the present invention.

Shown in FIG. 1 is a holder 2, in which a number of containers 3 are arranged. Each container 3 is used for and intended to contain a root system of a plant 4, which is to be grown in the container 3.

Further, a water supply system 5 leads to each of the containers 3 to water the plants 4.

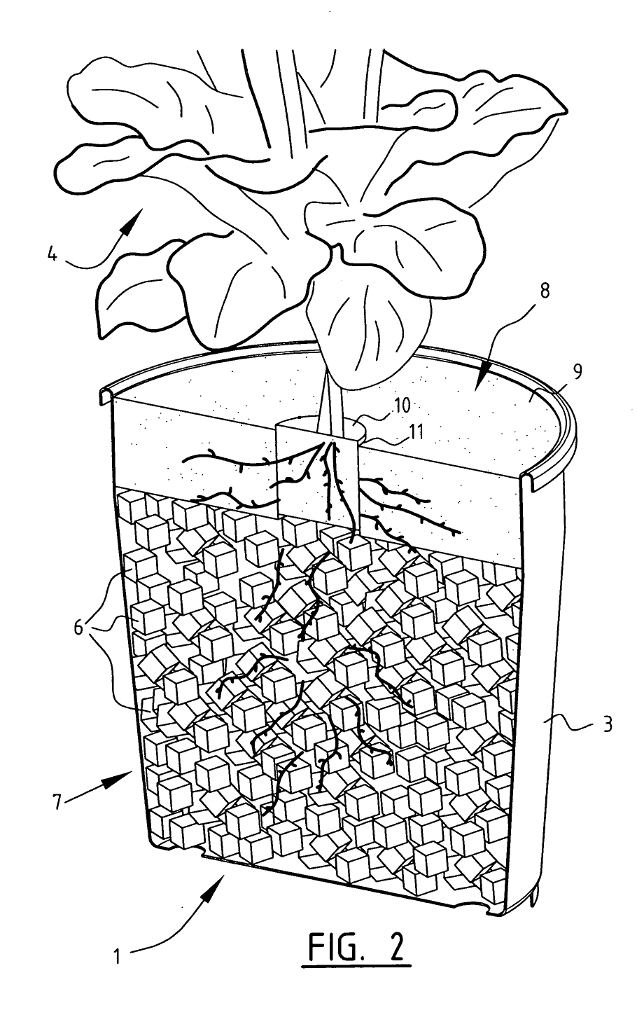

As shown in FIG. 2, which represents a cross-section through one of the containers 3, possibly in an embodiment as shown in FIG. 1, the container 3 or pot is filled with cubes of mineral wool material. The assembly of these cubes 6 of mineral wool material is designated the root substrate 7. On top of the root substrate 7, a top substrate 8 is arranged. The top substrate 8 comprises a disc 9 of mineral wool material.

The disc 9 of mineral wool material has a circumference shape and size, as a result of which the disc 9 of mineral wool material can be arranged in the container 3 or pot in a close fitting manner. Thus, the loose mineral wool cubes 6 of the root substrate 7 are encapsulated by the container 3 or pot and the top substrate 8 or disc 9. Thus, even though the mineral wool cubes 6 are loosely arranged in the root substrate, a sufficiently stable base for plant growth can be provided in accordance with the present invention. Moreover, especially when the plants to be grown are flower plants, such as Gerbera, the flowers can more easily be picked of or cut of, when these flowers are harvested, because the plant is placed sufficiently firm in the system 1 according to the invention than what would be the case, if only the loose mineral wool material cubes 6 where used. The more obvious solution of providing a monolithic block of mineral wool material to provide the desired sturdiness is known to exhibit other disadvantages, such as that root growth is not sufficiently promoted or even hindered, when a massive block of mineral wool material is utilized for growing such plants having formerable roots, or of which the roots are not easily grown.

Further, in the representation of FIG. 2, a plug 10 is arranged in a central hole 11 in the disc 9. The plug 10 is used to insert a seed, a seedling or a young plant, the roots of which may penetrate through the plug and enter into the space below the top substrate 8 in the form of disc 9 into the root substrate formed by the mineral wool cubes 6. The hole 11 in the disc 9 serves to identify a positive position through the plug 10. The plug 10 may however be omitted and a young plant or seedling may be inserted directly into the hole 11.

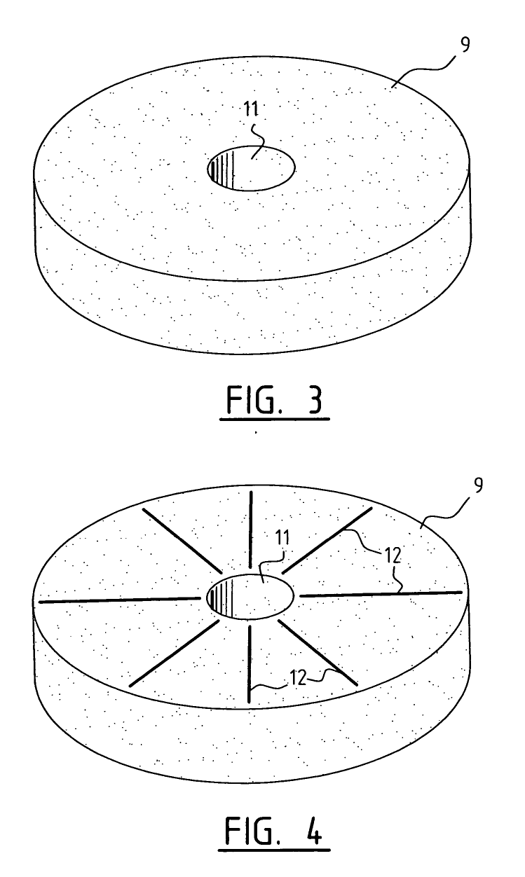

In FIG. 3 the mineral wool disc 9 is shown in isolation. More clearly herein, the hole 11 is visible. The disc 9 is shown in FIG. 3 to have practically smooth surfaces. In contrast, especially the circumferential surface of the disc can be provided with grooves or the like to enhance positive placement of the disc 9 in the container 3 or pot.

The disc 9 has a thickness, resulting in a sufficient stiffness to achieve the objectives of the present invention. The material chosen for the disc 9 is a mineral wool material, the parameters of which are also chosen or set in correspondence with the intended purpose thereof and provide the desired strength or sturdiness of the disc 9. Also the density, fiber orientation, thickness, etc., can be chosen or varied accordingly.

In FIG. 4, a further embodiment of a disc 9 is shown to have grooves or channels 12, extending radially from the hole 11 in an outward direction. The purpose of the grooves 12 is to enhance water distribution of the surface of the disc 9 and therewith also over the roots of the plant, growing underneath the disc 9, that forms a top substrate 8. Other measures can also be taken to achieve a desired fluid distribution. A spiraling groove can also be provided. Also, the material characteristics of the mineral wool material within the disc 9 can be varied in a horizontal direction, preferably in a direction radial relative to the hole 11, which defines a planting position, in which the plug 10 of FIG. 2 can be inserted.

It is to be noted, that several additional and alternative embodiments of the present invention will be apparent to a person skilled in the art, which are all to be interpreted as within the scope of protection for the present invention, as defined in the accompanying claims. For instance, a hole 11 need not be provided, and the disc can entirely be made of mineral wool material, without a hole. However, promoting root growth through the mineral wool material of the top substrate may, in such an embodiment, be more slow. The plug, which is preferable made of a mineral wool material, that is, for instance as a result of a lower density or other property thereof, preferably more easily penetrated by the roots of a growing plant, can also be incorporated or integrated into the top substrate, leaving no visible or discernable hole, like in the embodiments shown in the accompanying drawings. This would however mean a variation in the material properties of the disc 9 or more general the top substrate 8.

Such a variation could very possibly also comprise a top substrate having a variation in density in the thickness direction thereof. For instance, a disc-shaped top substrate could comprise two or more disc shaped layers on top of each other, each having other properties, like density, fiber thickness, fiber orientation, fiber length, etc.

Additionally or alternatively the top substrate can also be embodied such that root growth there through is promoted in a horizontal direction, s a result of which roots will grow horizontally outward and then downward into the root substrate, thus promoting an improved rood distribution over the top and root substrates. Also a firm assembled system is ensured hereby.

What is claimed is:

1. A plant growth system comprising:
a root substrate formed by a number of essentially independent mineral wool elements; and
a top substrate comprising at least one unitary or coherent mineral wool element.

2. The plant growth system of claim 1, further comprising a container for accommodating the root substrate and the top substrate and further comprising anchoring means for stable arrangement of at least the top substrate in the container.

3. The plant growth system of claim 2, wherein the anchoring means are formed by corresponding dimensioning of the container and the top substrate to form a fitting arrangement of the top substrate in the container.

4. The plant growth system of claim 1 wherein the top substrate has horizontal water distributing capability.

5. The plant growth system of claim 1 wherein the top substrate exhibits a fluid retention capability combined with a regular fluid release capability thereby providing a substantially continuous throughput of fluid to the root substrate.

6. The pant growth system of claim 1 wherein the top substrate comprises a disc of mineral wool material with one of a circular, rectangular, symmetrical and elongate circumference shape.

7. The pant growth system of claim 1 wherein the top substrate comprises a disc of mineral wool material having at least one hole for passage there through of a plant stem.

8. The plant growth system of claim 1, wherein the top substrate comprises at least one hole for accommodating a plug with a seed, a seedling or a young plant.

9. The plant growth system of claim 1 wherein the top substrate comprises fluid guiding channels for distribution of fluid over the top substrate.

10. The plant growth system of claim 1 wherein the top substrate comprises at least one planting position and fluid guiding channels for distribution of fluid over the top substrate, where the channels extend radially away from the at least one planting position.

11. The plant growth system of claim 1 wherein the top substrate comprises a disc of mineral wool material having a thickness of between 1 and 10 cm.

12. The plant growth system of claim 1 wherein the mineral wool material of the top substrate has a density of 40-120 kg/m³.

13. The plant growth system of claim 1 wherein the mineral wool elements of the root substrate have a form selected from the group consisting of at least one of blocks, balls, cubes, bars and pills of mineral wool material.

14. The plant growth system of claim 1 wherein the mineral wool elements of the root substrate are made from mineral wool material having a density of between 40 and 120 kg/m³.
